(19) United States
(12) Patent Application Publication
(10) Pub. No.: US 2026/0024238 A1
(43) Pub. Date: Jan. 22, 2026

(54) INPAINTING AND SYNTHESIZING GROUP PHOTO

(71) Applicant: Apple Inc., Cupertino, CA (US)

(72) Inventors: Boris Cherevatsky, Haifa (IL); Alosious Pradeep Prabhakar, Singapore (SG); Alistair M McFarlane, Dorking (GB)

(21) Appl. No.: 18/778,450

(22) Filed: Jul. 19, 2024

(51) Int. Cl. G06T 11/00; G06T 3/4007; G06T 7/00; G06T 7/246; G06T 7/33

(52) U.S. Cl. CPC G06T 11/00; G06T 3/4007; G06T 7/0002; G06T 7/246; G06T 7/33; G06T 2207/20221

(57) ABSTRACT

Disclosed are systems, apparatuses, processes, and computer-readable media for processing one or more images. For example, a method includes: obtaining a set of images including a plurality of target objects; determining a feature value for each target object of the plurality of target objects in each image of the set of images; identifying a key image from the set of images based on the feature value for each target object; identifying a first auxiliary image from the set of images based on the feature value associated with a first target object of the plurality of target objects; aligning the key image and the first auxiliary image based on optical flow between the key image and the first auxiliary image; and generating a synthesized image including a second target object in the key image and the first target object in the first auxiliary image.

### FIELD

The present disclosure generally relates to capturing and processing of images or frames. For example, aspects of the present disclosure relate to machine learning models for inpainting and synthesizing group photos.

### BACKGROUND

A camera serves as a sophisticated tool capable of capturing light and transforming it into image or frames through the utilization of an image sensor. These image or frames can encompass various forms, including still images or sequences of video frames. Cameras also include complex settings that are, categorized into image-capture and image-processing parameters and allow users to tailor the appearance of their photographs or videos according to their preferences.

Image-capture settings play a pivotal role in influencing the characteristics of an image during the capture process. Prior to or during image capture, adjustments can be made to parameters such as ISO, exposure time (commonly known as shutter speed), aperture size (referred to as f/stop), focus, and gain. Each of these settings contributes uniquely to the final outcome, enabling users to control factors like brightness, depth of field, and motion blur. Additionally, cameras offer a host of image-processing settings designed for post-capture manipulation. These settings encompass alterations to contrast, brightness, saturation, sharpness, levels, curves, and colors, among others. By harnessing the power of both image-capture and image-processing settings, photographers and videographers can exercise creative control over their visual content, achieving their desired aesthetic with precision and finesse.

### SUMMARY

The devices, circuits, components, or apparatuses (hereinafter, devices) described herein may be components of a device or may be integrated into a larger unit. As an example, the devices, circuits, engines, or apparatuses may be implemented in a mobile device (e.g., a mobile telephone or other mobile device), a wearable device, a wireless communication device, an augmented reality (AR), extended reality (XR), or virtual reality (VR) device such as a VR headset, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof.

The devices may include a camera or multiple cameras for capturing one or more images, and in some cases, can include a display or multiple displays for displaying one or more images, notifications, and/or other displayable data. Each device can include one or more sensors (e.g., one or more inertial measurement units (IMUs), such as one or more gyroscopes, one or more gyrometers, one or more accelerometers, or any combination thereof, and/or other sensor.

### BRIEF DESCRIPTION OF THE DRAWINGS

Illustrative embodiments of the present application are described in detail below with reference to the following drawing figures:

FIG. 1 is a diagram illustrating an example of an electronic device including a system-on-chip (SoC) for performing various operations in accordance with some examples;

FIG. 2 is a diagram illustrating a conceptual block diagram of an image synthesis system for synthesizing a group image based on a key image and objects in other images in accordance with some examples;

FIGS. 3A-3D are images illustrating synthesis of objects in different images into a synthesized image in accordance with some examples;

FIG. 4 is a flow diagram illustrating an example of a process for synthesizing a group image based on a key image and objects in other images in accordance with some examples;

FIG. 5 is a flow diagram illustrating a process for identifying a key image of a group image in accordance with some examples;

FIG. 6 is a flow diagram illustrating a process 600 for aligning the key image and the first auxiliary image in accordance with some examples;

FIG. 7 is an image illustrating segmentations of different objects in an image in accordance with some examples;

FIGS. 8A and 8B are images illustrating a guided filter that is applied to improve upscaling of various structures within an image in accordance with some examples;

FIG. 9 is a flow diagram illustrating a process for upscaling images from the machine learning (ML) model in accordance with some examples; and

FIG. 10 is a diagram illustrating an example of a computing system for implementing certain aspects described herein.

The figures depict and the detail description describes various non-limiting aspects for purposes of illustration only.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Electronic devices such as extended reality (XR) devices, virtual reality (VR) devices, augmented reality (AR) devices, mixed reality (MR) devices, etc., mobile phones, wearable devices such as watches, tablets, laptops, etc.) are increasingly equipped with cameras to capture image or frames. For example, an electronic device can include a camera to allow the electronic device to capture a video or image of a scene, a person, an object, etc. Additionally, cameras themselves are used in a number of configurations (e.g., handheld digital cameras, digital single-lens-reflex (DSLR) cameras, worn cameras (including body-mounted cameras and head-borne cameras), stationary cameras (e.g., for security and/or monitoring), vehicle-mounted cameras, etc.).

Users of electronic devices may use multiple exposures (e.g., image captures) to obtain a set of images with the highest quality. However, in a set of images with multiple target biological objects, it is impossible to guarantee that all target biological objects within a single image will share the best features. For example, blinking, facial expressions, facial orientation, and other micro-movements by an object can reduce the quality of a single image. This challenge becomes exponentially more complex as the number of target biological objects within the image increases.

In some aspects, generative machine learning (ML) models can be deployed to remove undesirable content from images by inpainting undesirable pixels from an image. Inpainting is a digital image processing technique used to fill in areas of an image by intelligently synthesizing information from surrounding regions. Inpainting processes include analyzing the surrounding pixels to understand the texture, color, and structure of the image, and then using this information to generate new pixels to replace the damaged or undesirable pixels. For example, generative ML models can remove a particular background object or foreground object. Current techniques of inpainting also use cloud-based processing, which requires off-device processing and uploading, which can incur significant delays and reduce user privacy.

Systems, apparatuses, processes (also referred to as methods), and computer-readable media (collectively referred to as “systems and techniques”) are described herein for on-device merging of multiple images (or exposures) and inpainting regions to create a synthesized image having the best features from multiple exposures. The systems and techniques can be performed on-device to increase user privacy and reduce delays.

For example, the systems and techniques may obtain a obtain a set of images including a plurality of target objects and determine a feature value for each target object of the plurality of target objects in each image of the set of images. The images can be captured in a video (e.g., each frame can be an image), a time-lapse, a live photo, or sequential exposures. The systems and techniques may identify a key image, which will serve as at least a background image and a foreground for at least one person, and at least one auxiliary image. As described in further detail below, a target object in the auxiliary will be removed from the auxiliary image and inserted into the key image, thereby forming a synthesized image. In this case, the systems and techniques capture the best features from the set of images to obtain the best image.

There may be minor differences in the pixels, such a minor tremble or movement associated with the image capture device and minor differences between each object and image. The systems and techniques include various techniques to align the content and inpaint when detail bordering at object in the foreground have undesirable or defective pixels. For example, the systems and techniques can generate pixels based on providing aligned backgrounds and segmented objects into a generative ML model. The systems and techniques can thereby generate a synthesized image with the best features on-device with minimal delay while preserving user privacy.

Various aspects of the application will be described with respect to the figures.

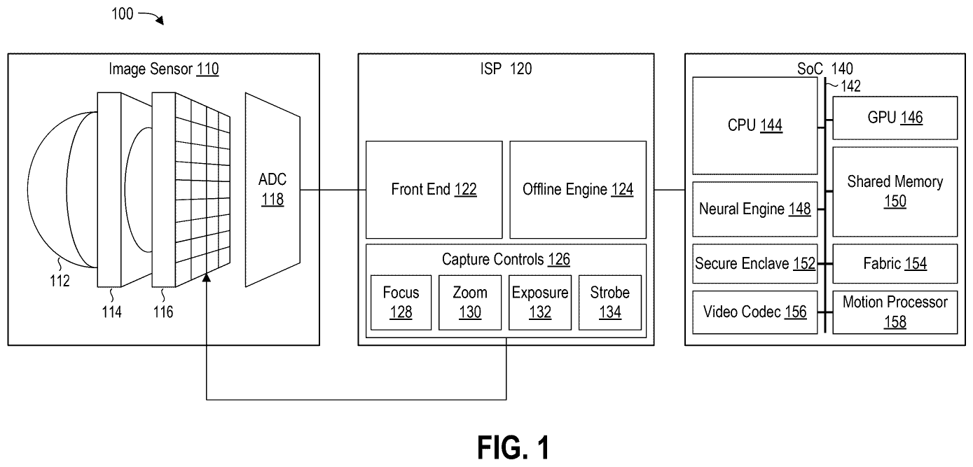

FIG. 1 is a block diagram illustrating an architecture of an electronic device 100 including an image sensor 110 for capturing various types of images. For example, the 100 can capture standalone images (or photographs) and/or can capture videos that include multiple images in a particular sequence (a live photo, a time-lapse, video frames, etc.).

The image sensor 110 includes a lens 112 or a lens assembly is positioned in front of a control mechanism 114. Light enters the image sensor 110 through the lens 112 which bends the light toward the sensor array 116, passes through the control mechanism 114, and then reaches a sensor array 116. When the image sensor is activated to capture a scene, the control mechanism 114 opens a shutter to allow light to pass through to the sensor array 116. The control mechanism 114 includes an aperture and is synchronized with the operation of a mirror (e.g., a DLSR camera) or an electronic shutter (e.g., a mirrorless camera) to ensure accurate exposure and focus.

The control mechanism 114 may control exposure, focus, and/or zoom based on information from the image sensor 110 and/or based on information from the ISP 120. The control mechanism 114 may include multiple mechanisms and components such as focal control, exposure control, and/or zoom control. The one or more control mechanisms 114 may also include additional control mechanisms besides those that are illustrated, such as control mechanisms controlling analog gain, flash, high dynamic range (HDR), depth of field, and/or other image capture properties.

In some cases, additional lenses may be included in the image sensor 110, such as a telephoto lens, a wide-angle lens, and an ultrawide lens. In some cases, the image sensor 110 can include one or more microlenses over each photodiode of the sensor array 116. The microlenses bend the light received from the lens 112 toward the corresponding photodiode before the light reaches the photodiode. The focus setting may be determined via contrast detection autofocus (CDAF), phase detection autofocus (PDAF), or some combination thereof. The focus setting may be referred to as an image capture setting and/or an image processing setting.

The image sensor 110 includes a sensor array 116 including one or more arrays of photodiodes or other photosensitive elements. For example, the sensor array 116 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

Each photodiode in the sensor array 116 measures an amount of light that is incident to the photodiode during the exposure period and can be converted into an analog value by the sensor array 116. The amount of luminance captured in each photodiode directly corresponds to the exposure settings (e.g., the aperture and the exposure length). The process of measuring the values of the sensor array 116 is referred to as a readout and provides values corresponding to the luminance and the readout process can be controlled based on an address or other information provided to the image sensor 110. The image sensor 110 can perform a binning process to bin the quad-color filter array pattern into a binned pattern. The binning process increases the signal-to-noise ratio (SNR), which increases sensitivity and reduces noise in the captured image. In one example, binning can be performed in low-light settings when lighting conditions are poor to generate a high-fidelity image with higher brightness characteristics and less noise. Binning may also be performed on a high-photodiode count array, such as an image sensor with 48 megapixels (MP), to produce high-fidelity images.

In some cases, different photodiodes may be covered by different color filters of a color filter array to measure light matching the color of the color filter covering the photodiode. Non-limiting examples of color filter arrays include a Bayer color filter array, a quad-color filter array (also referred to as a quad Bayer filter), and/or other color filter array. Other types of color filter arrays may use yellow, magenta, and/or cyan (e.g., emerald) color filters instead of or in addition to red, blue, and/or green color filters. Some image sensors may lack color filters altogether and may instead use different photodiodes throughout the pixel array (in some cases vertically stacked). The different photodiodes throughout the pixel array can have different spectral sensitivity curves and may respond to different wavelengths of light. Monochrome image sensors may also lack color filters and therefore lack color depth.

The image sensor 110 may include opaque and/or reflective masks that block light from reaching some photodiodes at certain times and/or from certain angles, which the image sensor 110 can use to implement PDAF. The image sensor 110 may also include an analog gain amplifier to amplify the analog signals output by the photodiodes and an analog-to-digital converter (ADC) 118 to convert the analog signals output of the photodiodes into digital signals.

The ISP 120 is configured to control the image sensor 110 based on various controls and user control and may include one or more processors. In one example, the ISP 120 may be a digital signal processor (DSP) and/or other type of processor and may process images in a non-volatile memory, a memory, a cache, or some combination thereof. In some cases, the ISP 120 may be implemented into a system-on-chip (SoC), such as the SoC 140, and connected to various other processing cores. The ISP 120 is illustrated as separate from the SoC 140 for illustrative purposes only.

The ISP 120 may include a front-end 122 that provides an initial stage of processing that occurs to manipulate raw image sensor data captured by a camera. For example, the front end performs tasks such as demosaicing (e.g., converting raw sensor data into full-color images), color correction, sharpening filters, denoising filters, white balance adjustment, noise reduction, lens distortion correction, color space conversion, downsampling, pixel interpolation, automatic exposure (AE) control, automatic gain control (AGC), CDAF, PDAF, and forming an HDR image by merging of multiple exposures of a scene, etc.

The ISP 120 may also include an offline engine 124, which refers to image processing that occurs after the raw sensor data has been captured and initially processed. The offline engine 124 may be integral into the ISP 120 itself or may be a software pipeline. The offline engine may use computationally intensive algorithms and techniques for advanced image enhancement, feature extraction, object recognition, or other tasks that require deeper analysis of the image data. For example, the offline engine 124 may be integrated into an Application Programming Interface (API) and activated based on software instructions. For example, the offline engine 124 may perform object detection within an image to detect a person and detect the orientation of the person's face with respect to a camera. An example of an API implementing at least part of the offline engine 124 includes the Apple® VisionKit API. The offline engine 124 may use external assets such as a central processing unit (CPU), a graphics processing unit (GPU), and a neural engine (e.g., a neural processing unit (NPU)). For example, the offline engine 124 may use a neural engine 148 of the SoC 140 to perform object detection and other vision-related tasks.

The ISP 120 may also include capture controls 126 for controlling various aspects of the image sensor 110. For example, the capture controls 126 can include an exposure control 128, a focus control 130, a zoom control 132, and a strobe control 134. The controls 126 can include other types of control such as using external information to further control the image sensor 110, a flash control, and other types of controls for the image sensor 110. For example, the ISP 120 may receive luminance information from an external luminance sensor (not shown) to control the exposure.

The exposure control 128 can obtain an exposure setting and control the control mechanism 114 to affect the image capture. For example, the exposure control 128 can control a size of the aperture (e.g., aperture size or f-stop), a duration of time for which the aperture is open (e.g., exposure time or shutter speed), a sensitivity of the image sensor 110 (e.g., ISO speed or film speed), analog gain applied by the image sensor 110, or any combination thereof. The exposure setting may be referred to as an image capture setting and/or an image processing setting.

The focus control 130 can obtain or determine a focus setting and adjust the position of the lens 112 relative to the position of the sensor array 116. For example, based on the focus setting, the focus control 130 can move the lens 112 closer to the sensor array 116 or farther from the sensor array 116 by actuating a motor or servo and adjusting a focus.

The zoom control 132 can obtain or determine a zoom setting and control a focal length of an assembly of lens elements (lens assembly) that includes the lens 112 and one or more additional lenses. For example, the zoom control 132 can control the focal length of the lens 112 by actuating one or more motors or servos to move one or more of the lenses relative to one another. The zoom setting may be referred to as an image capture setting and/or an image processing setting.

The strobe control 134 allows the electronic device 100 (or the user) to adjust the frequency and intensity of the flash (e.g., using a light emitting diode (LED)) on their device when capturing content. The strobe control 134 customizes various parameters associated with a strobe effect to improve lighting conditions. Non-limiting examples of adjustable parameters include a flash frequency, flash duration, brightness, color temperature, and so forth to achieve desired lighting effects.

The SoC 140 is a semiconductor device that is manufactured and configured to include various components to integrate functions within the SoC to reduce delays associated with external interfaces and other impediments. For example, the SoC 140 may include a bus 142 to facilitate efficient communication between various components within the SoC 140. In some examples, the bus 142 can include a 192-bit or 256-bit path to optimize data flow and provide a low-latency and high bandwidth data path between the various components described below.

In one aspect, the SoC 140 may include a CPU 144 configured to execute arithmetic and logic software instructions. In some aspects, the CPU 144 comprises a plurality of processing cores that may be configured to execute the functionality in parallel, and the processing cores may have different configurations. For example, the CPU 144 may include a plurality of performance cores for low-latency functions and a plurality of efficiency cores that consume less power than the performance cores. The variety of cores enables the SoC 140 to parallelize tasks in an efficient manner to ensure seamless operation of the various elements.

The SoC 140 may also include a GPU 146 that is configured for various graphics operations and visualization. For example, a GPU 146 may include a plurality of graphics processing cores for specialized processing such as floating-point math. In some cases, the GPU 146 can be designed by a third-party vendor and integrated into the SoC 140 using semiconductor manufacturing techniques. The GPU uses relevant data, such as vertices and textures, and processes the data in the graphic processing cores for parallel execution. In some cases, the graphics processing cores may also be referred to as shader cores. The graphics cores each perform complex mathematical computations such as vertex transformations, rasterization, fragment shading, and texture mapping to generate the final pixels of the rendered image, which may be displayed by the electronic device 100. The GPU 146 is optimized for floating point and vector mathematical operations such as warping, image analysis, and so forth.

The SoC 140 includes a neural engine 148 that includes a plurality of neural processing cores. A neural processing core includes arrays of multiply-accumulate (MAC) units and specialized instructions that are optimized for matrix operations, such as convolution and matrix multiplication. A neural processing core receives input data and performs matrix transformations and nonlinear activation functions to break down and parallelize matrix operations. The neural processing core is configured to perform tasks such as inference (e.g., runtime operation of an ML model) or training of deep learning models. For example, the neural engine 148 may perform computer vision tasks such as object recognition.

The SoC 140 may also include one or more accelerated processing units that are configured to perform specific functions. For example, the SoC 140 may include DSPs, motion sensing co-processors, video encoders and decoders, network co-processors, wireless communication modules, and so forth. As noted above, the SoC 140 may also include the ISP 120, and the ISP 120 is illustrated separately for the purpose of illustration only.

In some aspects, the SoC 140 may also include a shared memory 150 such as a random access memory (RAM) that is shared between the various components (e.g., CPU 144, GPU 146, neural engine 148, etc.). The SoC 140 may include additional hardware and software components to streamline memory allocation between the different components within the SoC 140.

The SoC 140 may also include a secure enclave 152 that is configured to secure the SoC 140 using various encryption techniques. The secure enclave may include encryption generation functionality, a true random number generator, a secure storage medium, and so forth. An example of a secure enclave 152 is a TPM module. In some cases, the SoC 140 or the secure enclave 152 may also be configured to interface with a security sub-system (not shown), such as a security module that is configured to securely store information that is not made available to the SoC 140. In one aspect, the security sub-system may securely store biometric information to enable various functions such as biometric authentication, etc.

The SoC 140 also includes a fabric 154 that is configured to facilitate interfacing the components of the SoC 140 internally and externally. As an example, the fabric 154 may include functionality to allocate the shared memory 150 between the various components within the SoC 140. The SoC 140 may interconnect the various components using a bus to enable access to the various components, such as enabling the CPU 144 to address a portion of the shared memory 150. In some aspects, the fabric 154 may also interface with external components such as a security sub-system, various bus interfaces (e.g., Peripheral Component Interconnect Express (PCI-e), thunderbolt, universal serial bus, a communication circuit for wireless communication, and so forth).

The SoC 140 may also include a video codec 156 (e.g., a video encoder and decoder) to encode raw video data and decode the encoded data for playback. The video codec 156 may be a hardware device due to increased efficiency, performance, power consumption, and advanced algorithms. In addition, hardware codecs ensure compatibility with a wide range of multimedia formats and standards to provide seamless playback and interoperability across different devices, applications, and services.

The SoC 140 can also include a motion processor 158 for interfacing with motion sensors. The motion processor 158 is configured to collect, process, and analyze data from various motion sensors, including accelerometers, gyroscopes, magnetometers, and sometimes barometers. The motion processor 158 is configured to continuously monitor motion and orientation data to accurately detect changes in device orientation, track movement patterns, and enable features such as step counting, activity recognition, gesture control, and augmented reality experiences. The motion processor 158 includes dedicated hardware that is configured to run with ultra-low power consumption and continually monitor and record data from the various sensors.

While the electronic device 100 is shown to include certain components, one of ordinary skill will appreciate that the electronic device 100 can include more components than those shown in FIG. 1. The components of the electronic device 100 can include software, hardware, or one or more combinations of software and hardware. For example, in some implementations, the components of the electronic device 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device 100.

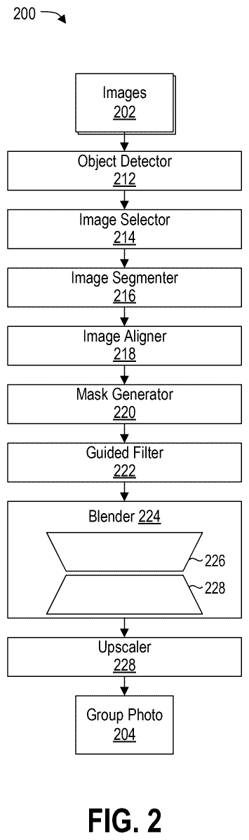

FIG. 2 is a diagram illustrating a conceptual block diagram of an image synthesis system 200 for synthesizing a group image based on a key image and objects in other images in accordance with some examples.

The image synthesis system 200 is configured to receive a plurality of images 202 (or frames) and synthesize a group photo 204 that includes uses features from some of the images 202 based on object characteristics. The images 202 can be a time lapse, a live photo, or a series of images that are captured with correlated capture settings, lighting conditions, camera orientation, and so forth. Because of the high correlation of the capture settings, objects within individual images that have a better appearance can be synthesized into the group photo 204 to improve the fidelity of the final image.

In some examples, the images 202 may be downsampled to a lower resolution to reduce compute complexity and improve feature extraction performance. For example, the set of original images may have a resolution of 4032×3024 and are downsampled into 1920×1440.

As an example, in group photos of multiple objects, it is not possible to guarantee that all target biological objects within a single image will share the best features. For example, blinking, facial expressions, facial orientation, and other micro-movements by an object can reduce the quality of a single image. This challenge becomes exponentially more complex as the number of target objects within the image increases. The image synthesis system 200 is configured to aggregate the best features of the different objects within the images 202 into the group photo 204 based on the operations described below.

The image synthesis system 200 includes an object detector 212 that is configured to identify the various objects within the images 202. For example, the object detector 212 may be an ML model configured to identify particular portions of different objects, such as the face of a person or an animal. The object detector 212 may also be configured to identify particular qualities of the object. As an example, the object detector 212 may identify faces within an image, identify an orientation of the face with respect to the image capture device, and detect features of that face. An orientation of the face may be a mathematical representation of the direction of the face, with 1.0 corresponding to the eyes of an object directly looking at the image capture device (e.g., normal to the image capture device) and 0.0 corresponding to the eyes of the object perpendicular to the image capture device. The object detector 212 may also detect features such as smile, non-verbal communication (e.g., gestures such as a wink or a smirk), eyelid features (e.g., blinking), obstruction of facial features, and other features and provide a score for the combined detected features.

In one example, the object detector 212 may assign an orientation score to each object within an image and a feature score to each object within the image. Table 1 below provides an example of orientation scores and feature scores of different objects in different images.

TABLE 1

| Image | Object | Orientation | Features |
|---|---|---|---|
| 1 | Person A | 0.9 | 75 |
| 1 | Person B | 0.9 | 90 |
| 1 | Person C | 0.6 | 66 |
| 2 | Person A | 0.8 | 90 |
| 2 | Person B | 0.9 | 81 |
| 3 | Person C | 0.7 | 70 |
| 3 | Person A | 0.6 | 55 |
| 3 | Person B | 0.9 | 55 |
| 3 | Person C | 0.8 | 85 |

In one example, the object detector 212 may be implemented based on a machine learning model that is trained to identify common features of images. For example, the object detector may be implemented in an API such as Apple VisionKit in connection with a neural engine (e.g., the neural engine 148 in FIG. 1). In other examples, the object detector 212 can also be executed in a generalized processor core (e.g., the CPU 144) or a graphics processor (e.g., the GPU 146). The object detector runs on-device (e.g., on the electronic device 100) and performs all processing without sending the images 202 for external processing. On-device ML processing guarantees user privacy of their content and also reduces processing time because wireless network connections vary significantly, cloud processing consumes additional time, and so forth.

The results of the object detector are provided to an image selector 214, which is configured to select a key image (e.g., a key frame) and at least one auxiliary image from the images 202. The key image is an image in the images 202 having a composite analysis that makes the image suitable as a base image that will provide at least a background and at least a single person. The key image may also include one or more target objects. The key image is selected based on a composite analysis of scores and target objects within the selected image and is not necessarily a maximum score.

The image selector 214 is also configured to identify auxiliary images from the images 202. The auxiliary images include target objects that are placed into the key image using the various systems and techniques described below, thereby generating the group photo 204. The target objects may be selected based on a composite analysis of scores for that target. For example, a maximum score can be assigned to an object based on the orientation and the features. An example maximum score can be a simple analysis, such as scaling the features based on the orientations or can be scaling the importance of the orientation and the features in a non-linear manner.

Table 2 below illustrates an example of the image selector 214 that selected images from Table 1 in connection with generating the group photo 204. In this example, the second image is selected as the key image because the composite score of orientation and features of Person A and Person B provide the best value proposition. That is, while the individual features of Person A are better in the first image, the image selector 214 may select the second image as the source image for Person A based on the aggregate features of Person A and Person B. Further, the image selector 214 selects the third image based on the composite analysis of the orientation and the features of the Person C.

TABLE 2

| Image | Object | Orientation | Features |
|---|---|---|---|
| 2 | Person A | 0.8 | 90 |
| 2 | Person B | 0.9 | 81 |
| 3 | Person C | 0.8 | 85 |

In some cases, the image selector 214 may also be configured as a user interface and enable an end user to individually select the key image and/or the at least one auxiliary image. For example, the image selector 214 may suggest the images in a user interface and may allow a user of the device to custom select images from the images 202 to include in the group photo 204.

The image synthesis system 200 may also include an image segmenter 216 that is configured to segment the objects within the key image and the auxiliary image. The image segmenter 216 may also be used in connection with a user interface to select a key image and the auxiliary image. The image segmenter 216 is also an ML model that is configured to map features of objects to an object. In many cases, different parts of a person can be occluded based on other objects within the scene. For example, a part of a first person can be occluded based on a second person having at least one body part in front of the first person.

The image segmenter 216 is configured to segment the key image and each auxiliary image and map the different segments to each corresponding object. For example, each segment that is identified by the image segmenter 216 can be mapped to a corresponding object detected by the object detector 212.

The segments are provided to an image aligner 218 that is configured to align the features of each image (or frame). In many cases, the camera that captured the images 202 is not perfectly stationary between images due to trembling, motion as a result of input, and so forth. A small amount of motion in a short period of time can create significant visual differences between different images. In this case, the image aligner 218 is configured to map features in the auxiliary images to features in the key image and generate a transformation for each target image. That transformation is then applied to each target image.

In one non-limiting example, the image aligner 218 may remove each object detected in the key image and each auxiliary image. The image aligner may then identify key features within the background of each image to identify common characteristics. For example, key points are features that are distinct and invariant to common image transformations (e.g., rotation, movement, and changes in illumination) and are identified using various techniques such as edge detection or various ML models. Corresponding key points are identified in each image and a transformation is identified from each corresponding auxiliary image to the key image. For example, a transformation can identify a translation (e.g., a rotation and/or a translation) of the image capture device between the key image from the key image to the corresponding auxiliary image.

Each target image is warped based on a corresponding translation from the auxiliary image to the key image. In this case, the target object's perspective and position from the auxiliary image can be mapped to correspond the key image irrespective of minor differences during the capture. In some cases, the image aligner 218 may also warp each segment (e.g., from the image segmenter 216) associated with each target object based on the translation.

In some cases, the image aligner 218 may also be configured to remove target objects from the key image based on segmentation. For example, in the example described above in Table 2, Person C is removed from the key image (e.g., the second image).

The image synthesis system 200 may include a mask generator 220 to generate a mask associated with the key image and each target image. The mask identifies a region and serves as a non-destructive technique to selectively apply changes to specific areas of the target and/or key image while leaving other areas unaffected. For example, the mask generator 220 can identify a background mask for the key image, which includes target objects that are retained within the key image. The mask generator can identify a foreground mask of each auxiliary image (e.g., after warping) based on the segmentation.

The image synthesis system 200 may also generate an inpainting mask that corresponds to a region between the key image and the auxiliary images. As will be described in further detail below, the content within the inpainting mask may be generated using generative techniques (e.g., using generative artificial intelligence (GenAI) such as diffusion or other techniques). In some cases, the mask generator 220 may be an ML model (e.g., executed in the neural engine 148) or may be a rule-based engine (e.g., executed in the GPU 146). In some cases, the inpainting mask can be a simple border region or may be associated based on a difference between the target objects in the key image and the target image.

The masks generated by the mask generator 220 are provided to a guided filter 222 to enhance and reduce noise associated with different aspects of the images. A target object may include various types of bordering structures that are particularly noisy and reduce image fidelity in the synthesis process. In a non-limiting example, a guided filter 222 is configured to enhance noisy details within the masks to reduce SNR. For example, the guided filter may be configured to reduce the noise of filamentous structures associated with the first target object. An example of a filamentous structure includes the hair of an object, but can also include clothing, accessories, and other content within the mask. Other types of filters can be used to further decrease the SNR of the different masks.

The masks, segments, and other related content are provided to an inpainter 224 that is configured to insert the objects from the auxiliary images into the key image. For example, in the example described above in Table 2, Person C is extracted from the third image and superimposed onto the key image (e.g., the second image). The inpainter 224 includes a machine learning model that is trained based on generative techniques to fill in material within the inpainting region, and then blend the differences between the key image, the generated inpainting content, and the target object (from the target image).

In some examples, the inpainter 224 includes an encoder 226 that encodes features within the source material (e.g., the key image, the auxiliary image) into representations (e.g., embeddings), generates representations of the content for the inpainting region, and blends the features of the inpainting region with the features in the key image and the auxiliary image. The inpainter 224 includes a decoder 228 that is configured to convert the representations into a synthesized image (e.g., that will be upscaled into the group photo 204). The inpainter 224 also includes a blender that is configured to blend the generated pixels into the synthesized image.

In some cases, the image synthesis system 200 may not use full-resolution images. For example, ML models may use smaller images because larger images contain more pixels and increase computational complexity during training and inference. ML models also rely on feature extraction and additional detail from larger images can introduce more noise and irrelevant information. Smaller resolution images often retain sufficient information for the model to learn relevant features while reducing the impact of noise.

The image synthesis system 200 can include an upscaler 230 that is configured to generate the group photo 204 based on the synthesized image generated by the inpainter 224. In one example, the upscaler 230 is configured to generate masks from the synthesized image, interpolate the masks (e.g., to 4032×3024), and apply the masks to the original images. In this manner, the upscaler 230 is configured to use the pixel from the full-resolution images and the lower resolution synthesized image, which has a lower resolution corresponding to the input images (e.g., 1920×1440) to generate the group photo 204 which has an image size corresponding to the original image (e.g., to 4032×3024).

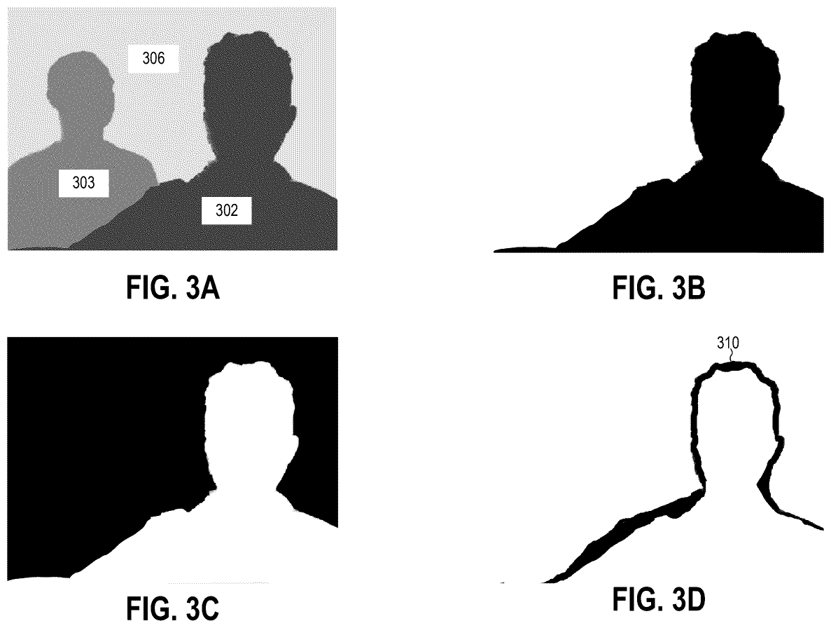

FIGS. 3A-3D are images illustrating synthesis of objects in different images into a single image in accordance with some examples. In particular, FIG. 3A illustrates an image that can be used in a group photo and includes multiple objects such as a first person 302 and a second person 304 that are in front of a background 306.

In one example, two or more images of the scene in FIG. 3A can be captured and merged based on the disclosed systems and techniques. FIG. 3B illustrates an example mask that can be generated based on object detection of the first person 302 from a first image, and FIG. 3C illustrates an example mask that can be generated based on object detection of the second person and the background from a second image. The systems and techniques described above can use the images and masks to insert the first person from the first image into the second image.

FIG. 3D illustrates a boundary region 310 between the first person in the second image and the first person in the first image may not match. Accordingly, a generative machine learning model (e.g., the inpainter 224) may be configured to generate pixels for the boundary region 310. For example, the generative machine learning model may generate pixels that fill in the boundary region based on the removed pixels and the region around the boundary region 310, and then blend the generated pixels into the synthesized image. As a result, the disclosed systems and techniques can use content across different images to generate a single image having the best combination of features. The disclosed systems and techniques also perform the image synthesis on-device, which is faster than offline processing in the cloud, and also preserves user privacy.

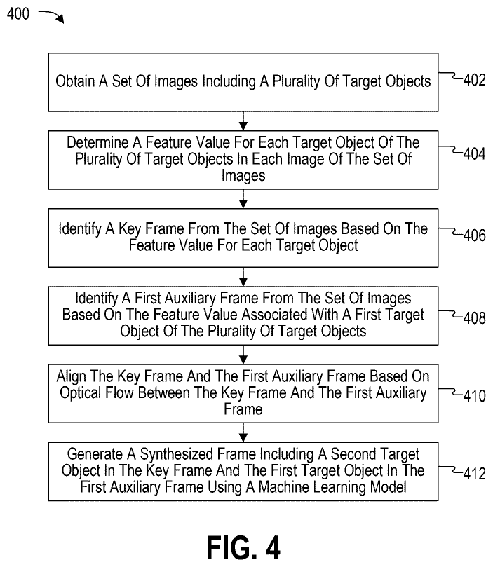

FIG. 4 is a flow diagram illustrating a process 400 for synthesizing a group image based on a key image and objects in other images in accordance with some examples. For example, the process 500 may be implemented by the image synthesis system 200 in FIG. 2. For the purpose of simplicity, the process 400 is described as being performed by an electronic device, which performs the method using a processing device such as an SoC (e.g., the SoC 140) using one or more components such as a processing core of the CPU 144, a graphics processing core of the GPU 146, or the neural engine 148.

At block 402, the electronic device may obtain a set of images including a plurality of target objects. For example, the electronic device may capture a plurality of photos such as a time-lapse, a hybrid photo (e.g., such as Apple Live Photo which captures 1.5 seconds of video and audio before and after the shutter is clicked to create a dynamic picture that can be viewed with movement and sound), multiple exposures, a video, etc. In general, the set of images should have highly correlated features and should be taken in the same session to have a substantially identical camera position, orientation, and lighting.

At block 404, the electronic device may determine a feature value for each target object of the plurality of target objects in each image of the set of images. For example, a user may select an option to generate a synthesized image based on at least two images in the electronic device. The electronic device may identify all images corresponding to the set of images (e.g., using a timestamp) and then analyze the objects within the images for the feature value (e.g., an orientation of the face, facial features, etc.). In one example, the feature value is associated with a combination of key features associated with each target object (e.g., an orientation of the target object with respect to the device and facial features of the target object). For example, the orientation can be a ratio identifying the relationship of an object's gaze with respect to a normal vector to the electronic device (e.g., a value of 1.0 indicates that a person or an animal is directly looking at the electronic device, and a 0.0 indicates that the person or animal's view is perpendicular to the electronic device. The facial features may be a score based on perceived quality, such as open eyes, smiling, and other common features that are desirable in a photo. In some examples, one or more ML models configured for detecting facial features can determine the orientation and the facial features. In some examples, a neural engine (e.g., the neural engine 148) may execute an ML model for detecting objects (e.g., faces of people or other animals) and provide the orientation value and the facial feature value.

At block 406, the electronic device may identify a key image from the set of images based on the feature values for each target object. As noted above, the key image is selected in consideration of feature values and a quantity of modifications to be made for the synthesized image. In some examples, the electronic device may implement a user interface to allow a user to select the key image.

At block 408, the electronic device may identify a first auxiliary image from the set of images based on the feature value associated with a first target object of the plurality of target objects. For example, the electronic device may determine that a second target object has their eyes closed for all but a particular image in the set of images and may select this particular image as the first auxiliary image. The electronic device may select as many auxiliary images as needed to address the target objects within the image.

At block 410, the electronic device may align the key image and the first auxiliary image based on the optical flow between the key image and the first auxiliary image. In some examples, micro-movements between images (or frames) can create small and perceptible shifts in perspective. The electronic device, as part of block 410, may identify the differences based on the identification of key points in the background features and may warp the first auxiliary image to correspond to the key image. In the event there are multiple auxiliary images, each image may be separately warped. In some examples, the warping of images may be performed within a GPU.

At block 412, the electronic device may generate a synthesized image including a second target object in the key image and the first target object in the first auxiliary image using a machine learning model. In some examples, the objects may be warped as noted above and may include a boundary region having a significant difference between the object in the key image and the warped object from the first auxiliary image. Placing the warped object from the first auxiliary image may cause gaps (e.g., empty pixels), mismatched pixels, or other visual defects that reduce the fidelity of the synthesized image. The electronic device may generate the boundary region pixels of the first target object based on the hallucination of pixels at the edges of the first target object using the set of images and the machine learning model. In this case, the electronic device may also blend the generated pixels with the pixels in the key image to reduce any visual artifacts.

The process 400 is configured to perform on-device synthesis and reduce the delay between capturing the images and generation of the synthesized image. For example, the process 400 can be performed in approximately three seconds based on current hardware and ML models, which will allow the user to preview and approve the synthesized image with minimal delay. The process of transporting multiple images to a cloud service and then receiving the result takes significantly longer and reduces the opportunities for recapturing the precise moment. In addition, performing on-device synthesis alleviates concerns related to user privacy because the data cannot be used for an auxiliary purpose (e.g., for training an ML model).

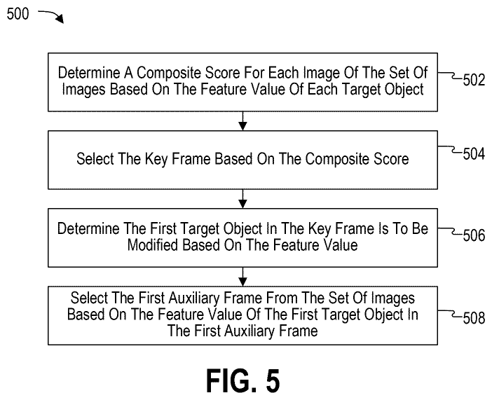

FIG. 5 is a flow diagram illustrating a process 500 for identifying a key image and at least one auxiliary image in accordance with some examples. For example, the process 500 may be implemented by the object detector 212 and the image selector 214 in FIG. 2. For purpose of simplicity, the process 500 is described as being performed by an electronic device, which performs the method using a processing device such as an SoC (e.g., the SoC 140) using one or more components such as a processing core of the CPU 144, a graphics processing core of the GPU 146, or the neural engine 148.

At block 502, the electronic device may determine a composite score for each image of the set of images based on the feature value of each target object. For example, the composite score can be associated with feature values of multiple target objects. The feature values may include an orientation of the object's features with respect to the image capture device (e.g., the electronic device) and facial features of the object.

At block 504, the electronic device may select the key image based on the composite score. In general, the key image may be selected based on the least modifications necessary to obtain the highest quality image. In other examples, the electronic device can present a user interface to allow the selection of the key image.

At block 506, the electronic device may determine the first target object in the key image is to be modified based on the feature value. For example, the key image may include a first target object and a second target object, and the first target object's eyes may be closed and the second target object may have an optimal feature value (e.g., eyes open, looking at the electronic device, etc.). In some examples, the electronic device can present a user interface to allow a user to select objects within a key image to replace.

At block 508, the electronic device may select the first auxiliary image from the set of images based on the feature value of the first target object in the first auxiliary image. For example, the set of images may include five images, and the electronic device selects a different auxiliary image with the first target object having an optimal feature value. For example, at block 506, the electronic device determines that the first target object's eyes are closed (e.g., a low facial feature score) and identifies the first auxiliary image based on a higher feature score of the first target object. In some examples, the electronic device can present a user interface to allow selection a user to select an image (or frame). For example, the user interface may allow the user to select images in which all users are looking in a single direction away from the electronic device.

In some aspects, blocks 506 and 508 are repeated for each target object that is to be replaced within the key image. In some cases, the electronic device may also select auxiliary images based on reduced segmentation. For example, if two target objects are within a single image with a substantially high feature score and will be replaced in the key image, the electronic device may use the image with the combination of the best features of the two target objects rather than different auxiliary images with a maximum feature score for the individual target object.

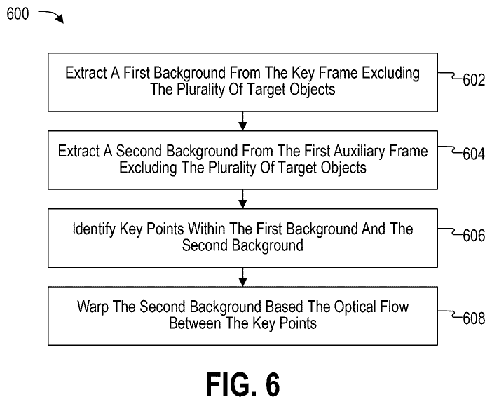

FIG. 6 is a flow diagram illustrating a process 600 for aligning the key image and the first auxiliary image in accordance with some examples. For example, the process 600 may be implemented by the image segmenter 216 and the image aligner 218 in FIG. 2. For the purpose of simplicity, the process 600 is described as being performed by an electronic device, which performs the method using a processing device such as an SoC (e.g., the SoC 140) using one or more components such as a processing core of the CPU 144, a graphics processing core of the GPU 146, or the neural engine 148.

The electronic device may extract backgrounds from each image in the set of images. For example, at block 602, the electronic device may extract a first background from the key image excluding the plurality of target objects. For example, an ML model may be configured to segment objects and parts of objects (e.g., occluded portions of an object), and each object can be removed from the key image. At block 602, only the background portion remains in the first background.

At block 604, the electronic device may extract a second background from the first auxiliary image excluding the plurality of target objects. At block 604, only the background portion remains in the second background.

At block 606, the electronic device may identify key points within the first background and the second background. In this case, the electronic device identifies identical key points because of the high correlation between the key frame (e.g., corresponding to the first background) and the first auxiliary image (e.g., corresponding to the second background).

At block 608, the electronic device may warp the second background based on an optical flow between the first background and the second background. For example, the electronic device may apply homography techniques to identify a translation that can be applied to align the first background and the second background. The aligned backgrounds can be provided to the ML model, which can use both images to generate pixels for the boundary region for the synthesized image. In other examples, the electronic device can also identify a rotation that can rotate from image to image. For example, the process of tapping the screen of the electronic device can cause a slight rotation that, while barely perceivable, can increase the difficulty in generating pixels.

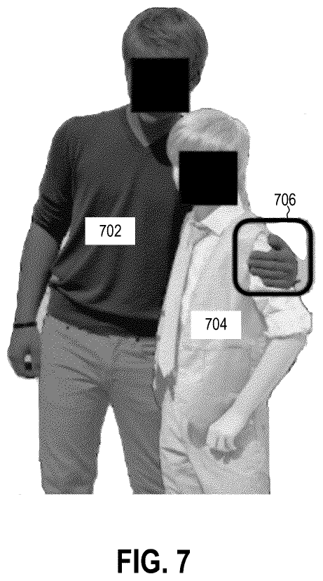

FIG. 7 is an image illustrating segmentation of different objects in an image in accordance with some examples. In this example, an ML model is configured to identify different objects within the scene and map different parts of the image to each different object. For example, the image includes a first person 702 standing adjacent to a second person 704, with a part of the first person 702 being occluded by the second person. A remainder portion 706 of the occluded part may be visible and is visibly disconnected from the first person 702 due to occlusion.

For example, the ML model is configured to identify occluded body parts and can map the occluded part to the correct object (e.g., the first person 702). The ML model can also generate masks associated with each object within the image and generate a background image.

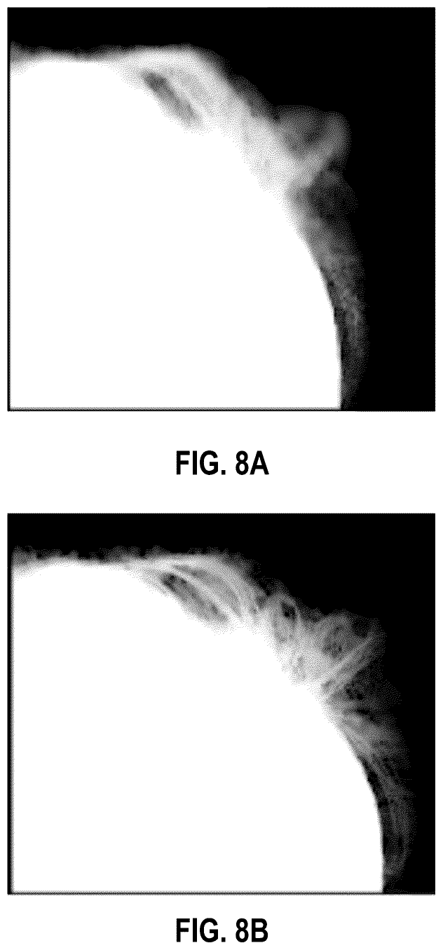

FIGS. 8A and 8B are images illustrating a guided filter that is applied to improve upscaling of various structures within an image in accordance with some examples.

FIG. 8A illustrates an example of lossy content that an image may experience during downsampling. Downsampling may be necessary because the ML is trained for content of a particular size. For example, an ML model (e.g., the inpainter 224) may be trained to receive images of a particular size (e.g., 1920×1440) and infer details because processing efficiency, memory constraints, overfitting with larger images, and ease of labeling smaller images. Smaller images are often used in ML models to balance the trade-offs between computational efficiency, memory usage, training time, risk of overfitting, and practical considerations of data labeling and deployment. As shown in FIG. 8A, filamentous structures (e.g., hair, clothing, etc.) may appear blurry.

In some examples, the images that are input into the ML model (e.g., the inpainter 224) may be filtered to improve the generation of pixels during inference. In one example, a guided filter (e.g., the guided filter 222) may be applied to the various images to preserve edges. For example, a guided filter 222 uses a guidance image to guide the smoothing operation to ensure that edges and fine details in the guidance image are preserved in the output. FIG. 8B illustrates an example output of the filamentous structures from FIG. 8A that are provided to an ML model for inference.

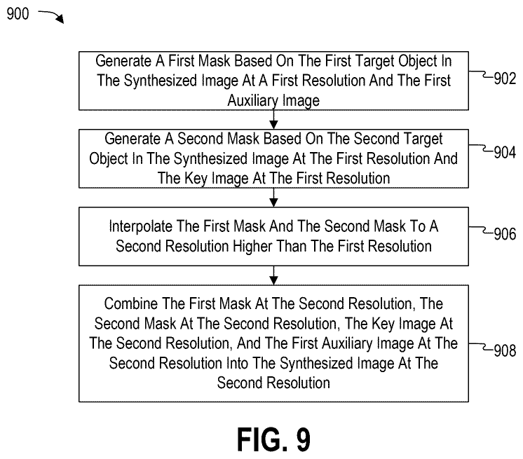

FIG. 9 is a flow diagram illustrating a process 900 for upscaling a synthesized image from the ML model in accordance with some examples. As described above, the ML model may be trained for inferring content with a lower resolution (e.g., 1920×1440) to reduce computation complexity, unnecessary detail, etc. The flow diagram illustrates a process of an upscaler (e.g., the upscaler 230) for upscaling content based on the synthesized output from the ML model (e.g., the inpainter 224). For example, the process 900 may be implemented by the upscaler 230 in FIG. 2.

As noted above, the ML model may use smaller images to balance the trade-offs between computational efficiency, memory usage, training time, risk of overfitting, and practical considerations of data labeling and deployment. However, the synthesized image will not have the desired resolution and quality of the image is reduced at this resolution. The process 900 can be used to upscale the content in accordance with some examples.

At block 902, the electronic device may generate a first mask based on the first target object in the synthesized image at a first resolution and the first auxiliary image. For example, the electronic device may determine a distance (e.g., a difference) between pixels in the synthesized image and the first auxiliary image, which generates the first mask. In this example, the first resolution is 1920×1440 and corresponds to the image sizes the ML model is trained for.

At block 904, the electronic device may generate a second mask based on the second target object in the synthesized image at the first resolution and the key image at the first resolution. For example, the electronic device may determine a distance (e.g., a difference) between pixels in the synthesized image and the key image, which generates the second mask.

At block 906, the electronic device may interpolate the first mask and the second mask to a second resolution higher than the first resolution. The second resolution may be a native resolution of the camera (e.g., 4032×3024).

At block 908, the electronic device may combine the first mask at the second resolution, the second mask at the second resolution, the key image at the second resolution, and the first auxiliary image at the second resolution into the synthesized image at the second resolution. For example, the electronic device may combine (e.g., multiply) pixels from the first mask (at the second resolution) with the first auxiliary image, multiple pixels from the second mask (at the second resolution), and sum the results of the multiplications (e.g., synthesized image=(first mask*first auxiliary image)+(second mask*second auxiliary image)), which yields the synthesized image at the second resolution. In another example of block 908, the electronic device may identify a distance in each mask and select a pixel from the closest image.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive IP-based data or other type of data.

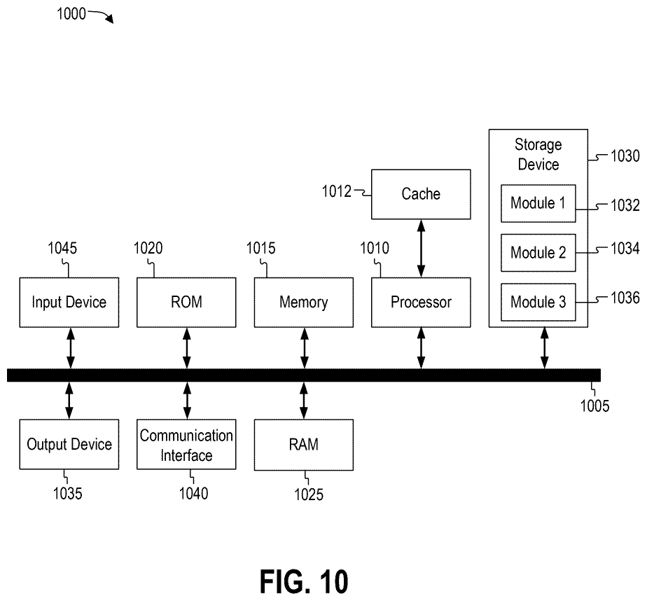

FIG. 10 is a diagram illustrating an example of a system for implementing certain aspects of the present technology. In particular, FIG. 10 illustrates an example of computing system 1000, which may be for example any computing device making up internal computing system, a remote computing system, a camera, or any component thereof in which the components of the system are in communication with each other using connection 1005. Connection 1005 may be a physical connection using a bus, or a direct connection into processor 1010, such as in a chipset architecture. Connection 1005 may also be a virtual connection, networked connection, or logical connection.

In some embodiments, computing system 1000 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1000 includes at least one processing unit (CPU or processor) 1010 and connection 1005 that communicatively couples various system components including system memory 1015, such as ROM 1020 and RAM 1025 to processor 1010. Computing system 1000 may include a cache 1012 of high-speed memory connected directly with, in close proximity to, or integrated as part of processor 1010.

Processor 1010 may include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which may represent any number of input mechanisms, such as a microphone for speech, a touch-sensitive screen for gesture or graphical input, keyboard, mouse, motion input, speech, etc. Computing system 1000 may also include output device 1035, which may be one or more of a number of output mechanisms. In some instances, multimodal systems may enable a user to provide multiple types of input/output to communicate with computing system 1000.

Computing system 1000 may include communications interface 1040, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1030 may include software services, servers, services, etc., that when the code that defines such software is executed by the processor 1010, it causes the system to perform a function. In some embodiments, a hardware service that performs a particular function may include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

What is claimed is:

1. A method of processing images in a device, comprising:
obtaining a set of images including a plurality of target objects;
determining a feature value for each target object of the plurality of target objects in each image of the set of images;
identifying a key image from the set of images based on the feature value for each target object;
identifying a first auxiliary image from the set of images based on the feature value associated with a first target object of the plurality of target objects;
aligning the key image and the first auxiliary image based on optical flow between the key image and the first auxiliary image; and
generating a synthesized image including a second target object in the key image and the first target object in the first auxiliary image.

2. The method of claim 1, wherein generating the synthesized image comprises:
generating, using a machine learning model, boundary region pixels of the first target object based on hallucination of pixels at edges of the first target object using the set of images and the machine learning model.

3. The method of claim 1, further comprising:
generating a first mask of the first target object from the first auxiliary image; and
upsampling the first mask using a guided upsampling filter for filamentous structures associated with the first target object.

4. The method of claim 1, wherein identifying the key image comprises:
determining a composite score for each image of the set of images based on the feature value of each target object; and
selecting the key image based on the composite score.

5. The method of claim 1, further comprising:
determining the first target object in the key image is to be modified based on the feature value; and
selecting the first auxiliary image from the set of images based on the feature value of the first target object in the first auxiliary image.

6. The method of claim 1, wherein aligning the key image and the first auxiliary image comprises:
extracting a first background from the key image excluding the plurality of target objects;
extracting a second background from the first auxiliary image excluding the plurality of target objects;
identifying key points within the first background and the second background; and
combining the first background and the second background into a combined background based the optical flow between the key points, wherein the combined background is input into a machine learning model.

7. The method of claim 1, wherein the feature value is associated with a combination of key features associated with each target object, and wherein the key features of a target object include an orientation of the target object with respect to the device and facial features of the target object.

8. The method of claim 1, wherein the set of images are downscaled.

9. The method of claim 8, wherein generating the synthesized image comprises:
generating a first mask based on the first target object in the synthesized image at a first resolution and the first auxiliary image;
generating a second mask based on the second target object in the synthesized image at the first resolution and the key image at the first resolution,
interpolating the first mask and the second mask to a second resolution higher than the first resolution; and
generating the synthesized image at the second resolution.

10. The method of claim 9, wherein generating the synthesized image comprises combining the first mask at the second resolution, the second mask at the second resolution, the key image at the second resolution, and the first auxiliary image at the second resolution into the synthesized image at the second resolution.

11. A computing device for processing images, comprising:
at least one memory; and
at least one processor coupled to the at least one memory and configured to:
obtain a set of images including a plurality of target objects;
determine a feature value for each target object of the plurality of target objects in each image of the set of images;
identify a key image from the set of images based on the feature value for each target object;
identify a first auxiliary image from the set of images based on the feature value associated with a first target object of the plurality of target objects;
align the key image and the first auxiliary image based on optical flow between the key image and the first auxiliary image; and
generate a synthesized image including a second target object in the key image and the first target object in the first auxiliary image.

12. The computing device of claim 11, wherein the at least one processor is configured to:
generate, using a machine learning model, boundary region pixels of the first target object based on hallucination of pixels at edges of the first target object using the set of images and the machine learning model.

13. The computing device of claim 11, wherein the at least one processor is configured to:
generate a first mask of the first target object from the first auxiliary image; and
upsample the first mask using a guided upsampling filter for filamentous structures associated with the first target object.

14. The computing device of claim 11, wherein the at least one processor is configured to:
determine a composite score for each image of the set of images based on the feature value of each target object; and
select the key image based on the composite score.

15. The computing device of claim 11, wherein the at least one processor is configured to:
determine the first target object in the key image is to be modified based on the feature value; and
select the first auxiliary image from the set of images based on the feature value of the first target object in the first auxiliary image.

16. The computing device of claim 11, wherein the at least one processor is configured to:
extract a first background from the key image excluding the plurality of target objects;
extract a second background from the first auxiliary image excluding the plurality of target objects;
identify key points within the first background and the second background; and
combine the first background and the second background into a combined background based the optical flow between the key points, wherein the combined background is input into a machine learning model.

17. The computing device of claim 11, wherein the feature value is associated with a combination of key features associated with each target object, and wherein the key features of a target object include an orientation of the target object with respect to the device and facial features of the target object.

18. The computing device of claim 11, wherein the set of images are downscaled.

19. The computing device of claim 18, wherein the at least one processor is configured to:
generate a first mask based on the first target object in the synthesized image at a first resolution and the first auxiliary image;
generate a second mask based on the second target object in the synthesized image at the first resolution and the key image at the first resolution,
interpolate the first mask and the second mask to a second resolution higher than the first resolution; and
generate the synthesized image at the second resolution.

20. The computing device of claim 19, wherein generating the synthesized image comprises combining the first mask at the second resolution, the second mask at the second resolution, the key image at the second resolution, and the first auxiliary image at the second resolution into the synthesized image at the second resolution.
